(19) United States
(12) Patent Application Publication
(10) Pub. No.: US 2025/0385629 A1
(43) Pub. Date: Dec. 18, 2025

(54) APPARATUS FOR AND METHOD OF CONTROLLING INVERTER FOR DRIVING MOTOR, AND VEHICLE INCLUDING THE SAME

(71) Applicants: HYUNDAI MOTOR COMPANY, SEOUL (KR); KIA CORPORATION, SEOUL (KR)

(72) Inventors: Ho Rim CHOI, Hwaseong-si (KR); Sang Woo PARK, Hwaseong-si (KR); Tae Jun MOON, Hwaseong-si (KR); Tae Il YOO, Hwaseong-si (KR); Jin Wook KANG, Hwaseong-si (KR)

(21) Appl. No.: 18/955,757

(22) Filed: Nov. 21, 2024

(30) Foreign Application Priority Data
Jun. 12, 2024 (KR) 10-2024-0076469

(51) Int. Cl. H02P 21/16; H02P 21/18; H02P 21/22

(52) U.S. Cl. CPC H02P 21/16; H02P 21/18; H02P 21/22

(57) ABSTRACT

Provided is an apparatus and method for controlling an inverter to drive a motor installed in a vehicle, and a vehicle including the same. The apparatus includes a current command generation unit. The current command generation unit generates a current command based on a torque command, determines a current compensation value in response that the motor is in a hill hold state and a junction temperature of any of three-phase switching elements in the inverter exceeds a predetermined threshold temperature, and varies the current command based on the current compensation value and outputs the varied current command.

### CROSS-REFERENCE TO RELATED APPLICATION

The present application claims the benefit of priority under 35 U.S.C. 119 to Korean Patent Application No. 10-2024-0076469 filed on Jun. 12, 2024, in the Korean Intellectual Property Office, the disclosure of which are incorporated herein by reference in its entirety.

### BACKGROUND

### Field of the Disclosure

Exemplary embodiments of the present disclosure relate to a technology of controlling an inverter for driving a motor, and more particularly, to an apparatus for and method of controlling an inverter for driving a motor installed in a vehicle, and a vehicle including the same.

### Description of Related Art

Electrified vehicles refer to vehicles such as electric vehicles (EVs) and fuel cell electric vehicles (FCEVs) that use a motor as a drive source. These vehicles drive the motor by converting direct current power stored in a main battery into three-phase alternating current power using an inverter. The motor's driving force is then transmitted to drive wheels to propel the vehicle.

In the case of electrified vehicles, the inverter can be used to control the torque of the drive motor to achieve a hill hold state, which allows the vehicle to remain stationary on an incline.

The hill hold state refers to a state where the motor does not rotate even though the inverter is providing power. Hill hold control is used to smoothly start a stopped vehicle on a hill or to prevent the vehicle from rolling back.

In the hill hold state, the inverter continuously outputs direct current instead of three-phase alternating current. As a result, the current flowing through the power modules of each phase becomes unbalanced, causing excessive direct current to flow through a specific power module (one of the three-phase power modules).

A concentrated overheating state may then occur in the specific power module, potentially causing permanent damage to the power module.

The above-described background technology corresponds to technical information possessed by the inventor for deriving the present disclosure or acquired during the development of the present disclosure, and cannot necessarily be regarded as well-known technology publicly available before the filing of the present disclosure.

### SUMMARY

The embodiments disclosed in the present disclosure are provided and relate to a technology to prevent concentrated overheating in the power module when hill hold control is engaged.

One objective of the embodiment is to control an inverter for driving a motor to mitigate overheating in switching elements of an inverter in a hill hold state.

Another technical objective of the embodiment is to control an inverter for driving a motor to compensate for a current command related to an overheated switching element in an overheating hill hold state, reduce the current input to the overheated switching element, and mitigate overheating in the switching element.

Finally, another technical objective of the embodiment is to provide an apparatus for and method of controlling an inverter for driving a motor, utilizing the technology of controlling an inverter for driving a motor disclosed in the present disclosure, and a vehicle including the same.

The technical objectives disclosed in the present disclosure are not limited to the aforementioned technical objectives, and unmentioned or other technical objectives will be clearly appreciated by those skilled in the art from the following description.

As a technical means for achieving the aforementioned technical objectives, a technology of controlling an inverter for driving a motor may be provided to mitigate overheating in switching elements of an inverter in a hill hold state.

Furthermore, the technology of controlling an inverter for driving a motor may be provided to compensate for a current command related to an overheated switching element in an overheating hill hold state, reduce the current input to the overheated switching element, and mitigate overheating in the switching element.

Furthermore, an apparatus for and method of controlling an inverter for driving a motor utilizing the technology of controlling an inverter for driving a motor disclosed in the present disclosure, and a vehicle including the same may be provided.

The apparatus for controlling an inverter for driving a motor in an embodiment of the present disclosure is an apparatus for controlling an inverter for driving a motor. The apparatus may include a current command generation unit. The current command generation unit may generate a current command based on a torque command, determine a current compensation value in response that the motor is in a hill hold state and a junction temperature of any of three-phase switching elements in the inverter exceeds a predetermined threshold temperature, and vary the current command based on the current compensation value and output the varied current command.

In the embodiment, the current command generation unit may include a current command generator configured to generate the current command, a current command variable controller configured to determine whether the motor is in the hill hold state, determine whether the junction temperature exceeds the threshold temperature in response that the motor is in the hill hold state, and output the current compensation value in response that the junction temperature exceeds the threshold temperature, and a synthesizer configured to add the current command and the current compensation value to output the added current command.

In the embodiment, the current command variable controller may receive the torque command and motor rotation speed, and determine that the motor is in the hill hold state in response that the motor rotation speed is less than a reference rotation speed, and the torque command exceeds a reference torque command.

In the embodiment, the current command variable controller may determine whether the torque command exceeds the reference torque command in response that the motor rotation speed is less than the reference rotation speed.

In the embodiment, the three-phase switching elements may include a U-phase switching element, a V-phase switching element, and a W-phase switching element, and the current command variable controller may determine whether the junction temperature of any of the U-phase, V-phase, and W-phase switching elements exceeds the threshold temperature.

In the embodiment, the current command variable controller may output a U-phase current compensation value in response that the junction temperature of the U-phase switching element exceeds the threshold temperature, output a V-phase current compensation value in response that the junction temperature of the V-phase switching element exceeds the threshold temperature, and output a W-phase current compensation value in response that the junction temperature of the W-phase switching element exceeds the threshold temperature.

In the embodiment, the current command variable controller may further receive a rotation angle of a rotor of the motor and output the current compensation value based on the torque command and the rotation angle.

In the embodiment, the current command variable controller may include memory configured to store a current compensation map composed of current compensation values for each torque command and rotation angle, a hill hold overheat determination module configured to determine whether the motor is in the hill hold state, determine whether the junction temperature exceeds the threshold temperature in response that the motor is in the hill hold state, and output an operation-on signal in response that the junction temperature exceeds the threshold temperature, and a current compensation value output module, in response to the operation-on signal, configured to output the current compensation value matched with the torque command and the rotation angle based on the current compensation map.

In the embodiment, the current compensation map may be configured to include current compensation values designed to minimize difference between each phase's junction temperature and the average of the sum of the junction temperatures of the U-phase switching element, the V-phase switching element, and the W-phase switching element.

Another embodiment provides a method of controlling an inverter for driving a motor by controlling an inverter for driving a motor. The method may include generating a current command based on a torque command, determining whether the motor is in a hill hold state, determining whether a junction temperature of any of the three-phase switching elements in the inverter exceeds a predetermined threshold temperature in response that the motor is in the hill hold state, outputting a current compensation value in response that the junction temperature exceeds the threshold temperature, and varying the current command based on the current compensation value and outputting the varied current command.

In the embodiment, the varying and outputting of the current command may include adding the current compensation value to the current command and outputting the added current command.

In the embodiment, the determining of whether the motor is in a hill hold state may include receiving a motor rotation speed and determining that the motor is in the hill hold state in response that the motor rotation speed is less than a reference rotation speed and the torque command exceeds a reference torque command.

In the embodiment, the determining of whether the motor is in a hill hold state may include determining whether the motor rotation speed is less than the reference rotation speed, and determining whether the torque command exceeds the reference torque command in response that the motor rotation speed is less than the reference rotation speed.

In the embodiment, the three-phase switching elements may include a U-phase switching element, a V-phase switching element, and a W-phase switching element, and the determining of whether the junction temperature of any of the three-phase switching elements in the inverter exceeds the threshold temperature may include determining whether the junction temperature of any of the U-phase, V-phase, and W-phase switching elements exceeds the threshold temperature.

In the embodiment, the outputting of a current compensation value may include outputting a U-phase current compensation value in response that the junction temperature of the U-phase switching element exceeds the threshold temperature, outputting a V-phase current compensation value in response that the junction temperature of the V-phase switching element exceeds the threshold temperature, and outputting a W-phase current compensation value in response that the junction temperature of the W-phase switching element exceeds the threshold temperature.

In the embodiment, the outputting of a current compensation value may include receiving a rotation angle of a rotor of the motor and outputting the current compensation value based on the torque command and the rotation angle.

In yet another embodiment, a vehicle with a motor as a drive source is disclosed. The vehicle may include an inverter configured to drive the motor, and an apparatus for controlling the inverter. The apparatus may include a current command generation unit that generates a current command based on a torque command, determines a current compensation value in response that the motor is in a hill hold state and a junction temperature of any of three-phase switching elements in the inverter exceeds a predetermined threshold temperature, and varies the current command based on the current compensation value and outputs the varied current command.

Specific details of various embodiments of the present disclosure, in addition to the means for solving the aforementioned problem, are provided in the following descriptions and drawings.

In the embodiments of the present disclosure, the technology of controlling an inverter for driving a motor may be provided to mitigate overheating in the switching elements of the inverter in the hill hold state.

Furthermore, the technology of controlling an inverter for driving a motor may be provided to compensate for the current command related to the overheated switching element in the overheating hill hold state, reduce the current input to the overheated switching element, and mitigate overheating in the switching element.

When the technology of controlling an inverter for driving a motor in the embodiments of the present disclosure is applied to a vehicle, it is possible to perform overheat protection control for the switching element in the hill hold state without increasing design costs.

Conventionally, output torque reduction control is performed to prevent damage to the switching element when its temperature increases, resulting in limitations due to reduced hill-climbing performance. However, when the technology of controlling an inverter for driving a motor in the embodiments of the present disclosure is applied, it is possible to perform overheat protection control for the switching element while maintaining hill-climbing performance, as output torque reduction control is unnecessary.

The effects of the present disclosure are not limited to those mentioned above. Other unmentioned effects will be clearly understood by those skilled in the art from the description below.

The discussion of the problem to be solved, the means for solving the problem, and the effects mentioned above do not define the essential features of the claims. Therefore, the scope of rights of the claims is not limited to the matters described in the description of the disclosure.

### BRIEF DESCRIPTION OF THE DRAWINGS

The accompanying drawings are intended to provide a better understanding of embodiments of the present disclosure, which are shown in conjunction with a detailed description. However, the technical features of the embodiments are not limited to the specific drawings, and the features disclosed in the drawings may be combined with each other to constitute a new embodiment.

FIG. 1 is a diagram showing a motor drive system with an apparatus for controlling an inverter for driving a motor, according to an embodiment of the present disclosure.

FIG. 2 is a diagram showing a configuration of a controller, according to the embodiment of FIG. 1.

FIG. 3 is a diagram showing a configuration of a current command generation unit, according to the embodiment of the present disclosure.

FIG. 4 shows an example of a U-phase d-axis current compensation map according to the embodiment of the present disclosure.

FIG. 5 shows an example of a U-phase q-axis current compensation map, according to the embodiment of the present disclosure.

FIG. 6 shows an example of a V-phase d-axis current compensation map according to the embodiment of the present disclosure.

FIG. 7 shows an example of a V-phase q-axis current compensation map according to the embodiment of the present disclosure.

FIG. 8 shows an example of a W-phase d-axis current compensation map according to the embodiment of the present disclosure.

FIG. 9 shows an example of a W-phase q-axis current compensation map according to the embodiment of the present disclosure.

FIG. 10 is a diagram illustrating a method of controlling an inverter for driving a motor according to another embodiment of the present disclosure.

FIG. 11 is a diagram illustrating step S1100 from FIG. 10 in detail.

### DETAILED DESCRIPTION

Advantages and features of the present disclosure and methods of achieving the same will become clear by referring to the embodiments described in detail below in conjunction with the accompanying drawings. However, the present disclosure is not limited to the embodiments disclosed herein but may be implemented in many different forms. The embodiments are provided only to complete the present disclosure and fully convey the scope of the disclosure to those skilled in the art. The present disclosure will be defined only by the scope of the appended claims.

The shapes, sizes, ratios, angles, numbers, and the like illustrated in the accompanying drawings for describing the various embodiments of the present disclosure are merely examples, and the present disclosure is not limited thereto. Like reference numerals generally denote like components throughout the specification. Furthermore, in the following description of the present disclosure, the specific descriptions of publicly known related technologies will be omitted when it is determined that the specific descriptions may obscure the subject matter of the embodiments disclosed in the present specification. The terms such as “including,” “having,” and “comprising” used herein are generally intended to allow other components to be added unless the terms are used with the term “only.” Any references to singular may include plural unless expressly stated otherwise.

Components are interpreted to include an ordinary error range even if not expressly stated.

When the relation of a time sequential order is described using the terms such as “after,” “continuously to,” “next to,” and “before,” the order may not be continuous unless the terms are used with the term “immediately” or “directly.”

The terms including ordinal numbers such as “first,” “second,” and the like may be used to describe various components, but these components are not limited by these terms. These terms are used merely to distinguish one component from the other components. Therefore, a first component to be mentioned below may be a second component in a technical concept of the present disclosure.

The terms such as first, second, A, B, (a), and (b) may be used to describe components of the present disclosure. Each of these terms is not used to define the essence, order, sequence, or number of a corresponding component but used merely to distinguish the corresponding component from other components. When a component is described as being “connected,” “coupled,” or “linked” to another component, the component may be directly connected or linked to the other component. However, it should be understood that another component may be “interposed” between the components, which may be indirectly connected or linked unless specifically stated otherwise.

The term “at least one” should be understood as including any combination of one or more of the associated components. For example, the meaning of “at least one of a first component, a second component, and a third component” includes any combination of two or more of the first component, the second component, and the third component as well as the first component, the second component, or the third component.

Each feature of the various embodiments of the present specification may be partially or fully combined or merged with each other, and various technical interconnections and operations are possible. Each embodiment may be implemented independently of the others or implemented together in association with other embodiments.

Since the scale of the components shown in the drawings is different from the actual scale for ease of description, the present disclosure is not limited to the scale shown in the drawings.

An apparatus for and method of controlling an inverter for driving a motor, and a vehicle including the same according to an embodiment of the present disclosure will be described hereinafter with reference to the accompanying drawings.

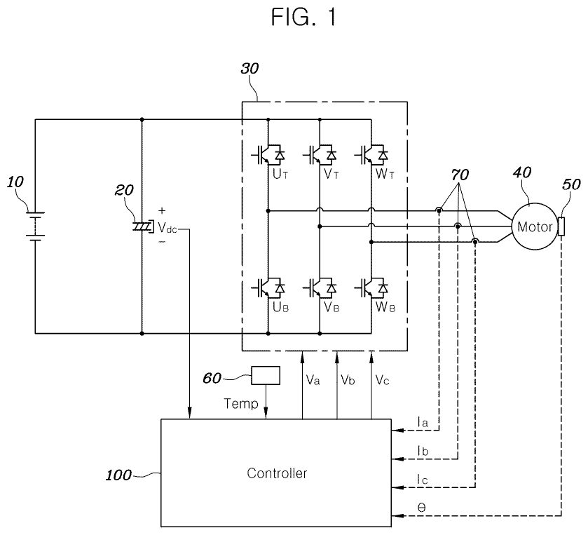

FIG. 1 is a diagram showing a motor drive system with an apparatus for controlling an inverter for driving a motor according to an embodiment of the present disclosure.

A motor drive system may be provided in a vehicle and may include an energy storage device 10, a direct current link capacitor 20 connected between both terminals of the energy storage device 10, an inverter 30, a motor 40, a position sensor 50, a temperature sensor 60, a current sensor 70, and a controller 100.

The energy storage device 10 is configured to store electrical energy in the form of direct current for driving the motor 40, such as a battery, and may output direct current power.

The direct current link capacitor 20 may be connected to both terminals of the energy storage device 10 and charged by power output from the energy storage device 10 to form a direct current link voltage Vdc. This direct current link voltage Vdc may be an input voltage for the inverter 30 and be provided to the controller 100.

The inverter 30 may be configured to convert direct current power supplied from the energy storage device 10 into alternating current power for driving a motor.

The inverter 30 may include three legs connected in parallel to both terminals of the energy storage device 10. Each leg may include a pair of switching elements (UT, UB/VT, VB/WT, WB) connected in series.

Each pair of switching elements (UT, UB/VT, VB/WT, WB) may be controlled to be in an on/off state by a pulse width modulation (PWM) signal provided by the controller 100 and may output drive power for a single phase (U phase/V phase/W phase).

For example, a pair of U-phase switching elements UT and UB may output U-phase current, a pair of V-phase switching elements VT and VB may output V-phase current, and a pair of W-phase switching elements WT and WB may output W-phase current.

In a hill hold state, the inverter 30, under the control of the controller 100, may output direct current to the three phases (U-phase direct current, V-phase direct current, and W-phase direct current).

The motor 40 is configured to generate torque based on the three-phase alternating current power supplied from the inverter 30, and a variety of motor types known in the art may be employed. In a vehicle, a motor that provides torque to the drive wheels of the vehicle may be referred to as a drive motor.

In the hill hold state, the motor 40 may not generate torque due to direct current output from the inverter 30.

The position sensor 50 may detect a position of a rotor of the motor 40, specifically a rotation angle θ of the motor rotor, and continuously output the detected motor rotation angle (or rotor rotation angle or rotation angle) θ. This motor rotation angle θ may be provided to the controller 100.

For example, the position sensor 50 may continuously output a rotation angle detection signal, which includes information about the motor rotation angle θ. For example, the position sensor 50 may include a resolver, and the configuration for implementing the position sensor 50 is not limited thereto.

The temperature sensor 60 may detect a junction temperature Temp of multiple switching elements (UT, UB, VT, VB, WT, WB) configured in the inverter 30 and continuously output the detected junction temperature Temp. This junction temperature Temp may be provided to the controller 100.

The junction temperature Temp detected by the temperature sensor 60 may include the detected junction temperature of a U-phase switching element (U-phase switching element junction temperature), the detected junction temperature of a V-phase switching element (V-phase switching element junction temperature), and the detected junction temperature of a W-phase switching element (W-phase switching element junction temperature).

For example, a pair of U-phase switching elements UT and UB may output U-phase current, a pair of V-phase switching elements VT and VB may output V-phase current, and a pair of W-phase switching elements WT and WB may output W-phase current.

The current sensor 70 may be disposed between the inverter 30 and the motor 40, detect the three-phase currents supplied from the inverter 30 to the motor 40, and output detection values (Ia, Ib, Ic). These detection values (Ia, Ib, Ic) may be provided to the controller 100.

The controller 100 may perform pulse width modulation (PWM) control, which appropriately modulates a duty cycle (duty ratio) of the switching elements (UT, UB, VT, VB, WT, WB) of the inverter 30 to control torque of the motor 40 to a desired value (torque command).

For the PWM control of the inverter 30, the controller 100 may receive a torque command and a magnetic flux command from an external higher-level controller or sensor.

Furthermore, the controller (or apparatus for controlling an inverter for driving a motor) 100 may perform the PWM control of the inverter 30 based on a direct current link voltage Vdc formed in the direct current link capacitor 20, a motor rotation angle θ output from the position sensor 50, a junction temperature Temp of the switching elements (UT, UB, VT, VB, WT, WB) output from the temperature sensor 60, and detection values (Ia, Ib, Ic) of the three-phase currents output from the current sensor 70.

In the hill hold state, the controller 100 may generate a current command, which enables temperature balance control to minimize the temperature difference among the switching elements (UT, UB, VT, VB, WT, WB) based on input information. The controller 100 may generate voltage commands (Va, Vb, Vc) for each phase, allowing the inverter 30 to output current corresponding to the generated current command, thereby controlling the on/off state of the switching elements (UT, UB, VT, VB, WT, WB) in the inverter 30.

For example, the controller 100 may be implemented with at least one processor. The processor may be a data processing device implemented in hardware with a circuit having a physical structure designed to execute desired operations. For example, the desired operations may include code or instructions contained in a program.

For example, the data processing device implemented in hardware may include a microprocessor, a central processing unit, a processor core, a multi-core processor, a multiprocessor, an application-specific integrated circuit (ASIC), or a field programmable gate array (FPGA).

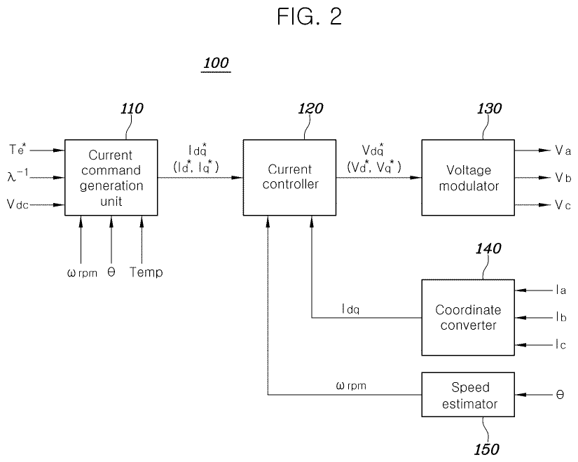

FIG. 2 is a diagram showing a configuration of the controller 100 according to the embodiment of the present disclosure.

Referring to FIG. 1 and FIG. 2, the controller 100 may include a current command generation unit 110, a current controller 120, a voltage modulator 130, a coordinate converter 140, and a speed estimator 150. The configuration of the controller 100 is not limited to these components.

The current command generation unit 110 may generate a current command Idq* based on input information for generating the current command, and output the generated current command Idq* to the current controller 120. In this case, the current command Idq* may include a d-axis current command Id* and a q-axis current command Iq*.

The current command generation unit 110 may generate a current command Idq based on a magnetic flux-based current command map.

In the present embodiment, the current command generation unit 110 may generate the current command Idq* based on an input torque command Te*, an inverse magnetic flux λ−1, and a direct current link voltage Vdc.

The current command generation unit 110 may vary the current command Idq* and output the varied current command to the current controller 120 in response that the junction temperature Temp of any of the three-phase switching elements (UT, UB, VT, VB, WT, WB) included in the inverter 30 exceeds a predetermined threshold temperature.

In the present embodiment, the current command generation unit 110 may determine whether the hill hold state occurs based on the input torque command Te* and a motor rotation speed ωrpm. In the case of the hill hold state, the current command generation unit 110 may determine whether the junction temperature Temp of any of the three-phase switching elements (UT, UB, VT, VB, WT, WB) exceeds the predetermined threshold temperature.

For example, the current command generation unit 110 may determine that the hill hold state occurs in response that the motor rotation speed ωrpm is less than a predetermined reference rotation speed and the torque command Te* exceeds a predetermined reference torque command.

In response that the junction temperature Temp of any of the three-phase switching elements (UT, UB, VT, VB, WT, WB) exceeds the predetermined threshold temperature, the current command generation unit 110 may determine a current compensation value based on a torque command Te* and a rotor rotation angle θ.

In the present embodiment, the current command generation unit 110 may determine the current compensation value based on a current compensation map composed of current compensation values according to the torque command Te* and rotor rotation angle θ.

The current command generation unit 110 may add the current compensation value to the current command Idq and output the added current command Idq.

The current controller 120 may receive the current command Idq output from the current command generation unit 110, generate a phase voltage command (or current control value) Vdq* corresponding to the current command, and output the generated phase voltage command Vdq* to the voltage modulator 130. In this case, the phase voltage command Vdq* may include a d-axis voltage command Vd* and a q-axis voltage command Vq*.

The current controller 120 may correct the phase voltage command Vdq* based on feedback information to eliminate torque errors.

For example, the current controller 120 may receive the current command Idq, converted from the current detection values (Ia, Ib, Ic) detected by the current sensor 70 to d/q-axis currents, from the coordinate converter 140. Furthermore, the current controller 120 may receive the motor rotation speed ωrpm, estimated based on the rotor rotation angle θ detected by the position sensor 50, from the speed estimator 150.

The voltage modulator 130 may perform the PWM to modulate the phase voltage command Vdq* output from the current controller 120, generate terminal voltage commands (Va, Vb, Vc) as PWM signals, and output these terminal voltage commands to the inverter 30.

For example, the voltage modulator 130 may perform space vector pulse width modulation (SVPWM) to modulate the phase voltage command Vdq* into terminal voltage commands (Va, Vb, Vc) as PWM signals.

The coordinate converter 140 may convert the current detection values (Ia, Ib, Ic), detected by the current sensor 70, into d/q-axis currents Idq and output the resulting currents. For example, the coordinate converter 140 may output the d/q axis currents Idq to the current controller 120. For example, the coordinate converter 140 may be referred to as a synchronous coordinate phase converter or a three-phase/dq coordinate converter.

The speed estimator 150 may estimate the motor rotation speed ωrpm based on the rotor rotation angle θ detected by the position sensor 50.

For example, the speed estimator 150 may include a differentiator and output the estimated motor rotation speed ωrₚₘ to the current controller 120.

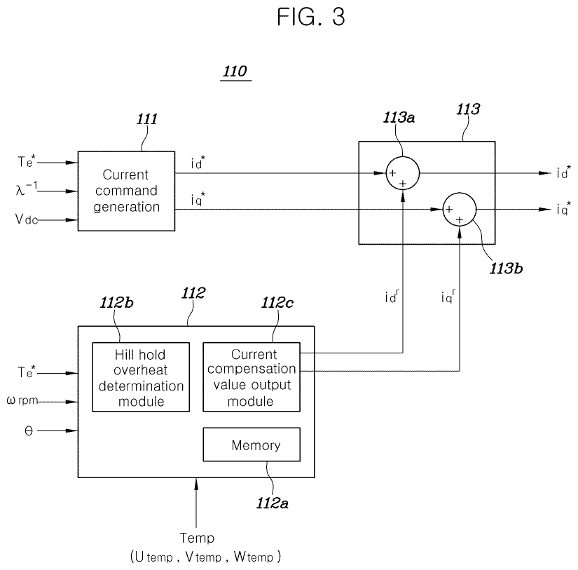

FIG. 3 is a diagram showing a configuration of the current command generation unit 110 according to the embodiment of the present disclosure.

Referring to FIG. 1, FIG. 2 and FIG. 3, the current command generation unit 110 may include a current command generator 111, a current command variable controller 112, and a synthesizer 113.

Hereinafter, for ease of description, the current command generated by the current command generator 111 will be referred to as the ‘source current command.’ The current command that is varied from the source current command will be referred to as the ‘variable current command.’ The final current command output from the synthesizer 113 will be referred to as the current command.

In other words, the current command Id* and Iq* may refer to the final current command output from the current command generation unit 110, and the current command may be either the source current command or the variable current command.

The current command generator 111 may generate the source current command idq* based on an input torque command Te*, an inverse magnetic flux λ−1, and a direct current link voltage Vdc.

For example, the current command generator 111 may generate the source current command idq* based on a magnetic flux-based current command map.

The current command generator 111 may generate a d-axis source current command id* and a q-axis source current command iq*. The d-axis source current command id* may be input to a first synthesis module 113a of the synthesizer 113, and the q-axis source current command iq* may be input to a second synthesis module 113b of the synthesizer 113.

In the case of overheating in the hill hold state, the current command variable controller 112 may output current compensation values idr and iqr to the synthesizer 113.

In the present embodiment, the current command variable controller 112 may include memory 112a, a hill hold overheat determination module 112b, and a current compensation value output module 112c.

The memory 112a may store the current compensation map composed of current compensation values according to a torque command Te* and a rotor rotation angle θ.

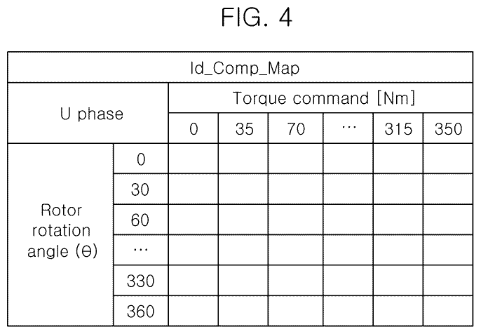

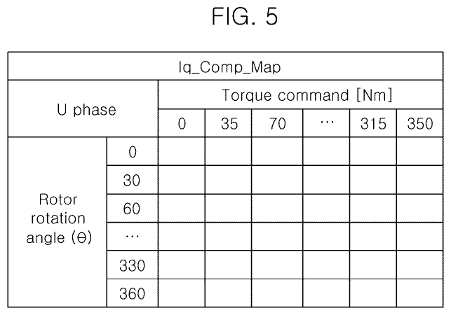

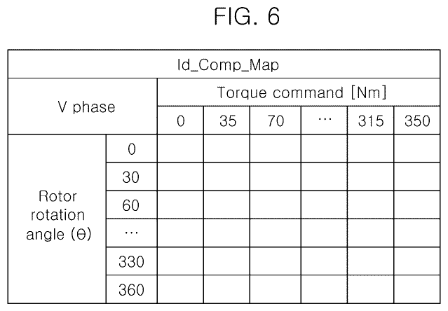

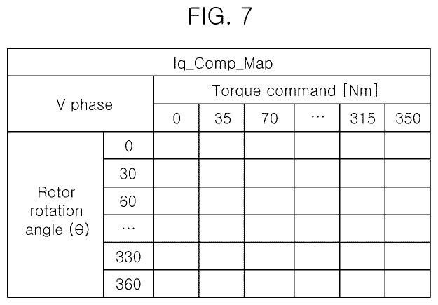

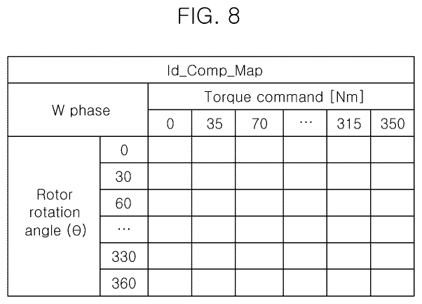

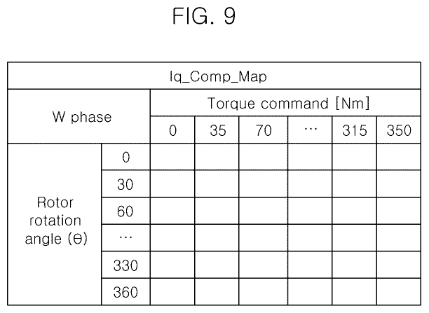

FIG. 4, FIG. 5, FIG. 6, FIG. 7, FIG. 8, and FIG. 9 show examples of the current compensation map according to the embodiment of the present disclosure.

Specifically, FIG. 4 and FIG. 5 show examples of a U-phase d-axis current compensation map and a U-phase q-axis current compensation map according to the embodiment of the present disclosure. FIG. 6 and FIG. 7 show examples of a V-phase d-axis current compensation map and a V-phase q-axis current compensation map according to the embodiment of the present disclosure. FIG. 8 and FIG. 9 show examples of a W-phase d-axis current compensation map and a W-phase q-axis current compensation map according to the embodiment of the present disclosure.

The current compensation map may include a map composed of U-phase current compensation values (U-phase current compensation map) (see FIG. 4 and FIG. 5), a map composed of V-phase current compensation values (V-phase current compensation map) (see FIG. 6 and FIG. 7), and a map composed of W-phase current compensation values (W-phase current compensation map) (see FIG. 8 and FIG. 9).

The U-phase current compensation map, V-phase current compensation map, and W-phase current compensation map may include current compensation values based on a torque command Te* and a rotor rotation angle θ (see FIG. 4, FIG. 5, FIG. 6, FIG. 7, FIG. 8, and FIG. 9), respectively.

The U-phase current compensation map may include the U-phase d-axis current compensation map (see FIG. 4) and the U-phase q-axis current compensation map (see FIG. 5). The V-phase current compensation map may include the V-phase d-axis current compensation map (see FIG. 6) and the V-phase q-axis current compensation map (see FIG. 7). The W-phase current compensation map may include the W-phase d-axis current compensation map (see FIG. 8) and the W-phase q-axis current compensation map (see FIG. 9).

In the present embodiment, the current compensation map may include current compensation values designed to minimize difference between each phase's junction temperature and the average of the sum of the junction temperatures (Utemp, Vtemp, Wtemp) of the U-phase switching element, the V-phase switching element, and the W-phase switching element.

For example, the memory 112a may be implemented with at least one of storage media (record media) such as flash memory, a hard disk, a secure digital card (SD card), random access memory (RAM), static random access memory (SRAM), read only memory (ROM), programmable read only memory (PROM), electrically erasable and programmable ROM (EEPROM), erasable and programmable ROM (EPROM), a register, a removable disk, and web storage.

Referring back to FIG. 3, the hill hold overheat determination module 112b may determine whether there is overheating in the three-phase switching elements (UT, UB, VT, VB, WT, WB) of the inverter 30 in the hill hold state.

The hill hold overheat determination module 112b may determine whether the hill hold state occurs based on a torque command Te* and a motor rotation speed ωrpm, and may determine whether at least one of the junction temperatures (Utemp, Vtemp, Wtemp) of the three-phase switching elements (UT, UB, VT, VB, WT, WB) exceeds the predetermined threshold temperature.

In the present embodiment, when the hill hold state occurs, the hill hold overheat determination module 112b may determine whether at least one of the junction temperatures (Utemp, Vtemp, Wtemp) of the three-phase switching elements (UT, UB, VT, VB, WT, WB) exceeds the predetermined threshold temperature.

In response that at least one of the junction temperatures (Utemp, Vtemp, Wtemp) of the three-phase switching elements (UT, UB, VT, VB, WT, WB) exceeds the predetermined threshold temperature, the hill hold overheat determination module 112b may determine that there is overheating in the hill hold state.

In response that the hill hold overheat determination module 112b determines that there is overheating in the hill hold state, the hill hold overheat determination module 112b may output an operation-on signal to the current compensation value output module 112c.

In response that the current compensation value output module 112c receives the operation-on signal from the hill hold overheat determination module 112b, the current compensation value output module 112c may output current compensation values idr and iqr to the synthesizer 113 based on the current compensation map stored in the memory 112a.

For example, the current compensation value output module 112c may output a d-axis current compensation value idr to the first synthesis module 113a of the synthesizer 113, and a q-axis current compensation value iqr to the second synthesis module 113b of the synthesizer 113.

The current compensation value output module 112c may search the current compensation map stored in the memory 112a to find the current compensation values idr and iqr corresponding to the input torque command Te* and rotor rotation angle θ, and output these values idr and iqr to the synthesizer 113.

The synthesizer 113 may output the current command Idq* based on the source current commands id* and iq* input from the current command generator 111 and the current compensation values idr and iqr input from the current command variable controller 112.

Depending on whether the current compensation values idr and iqr are input, the synthesizer 113 may output the source current commands id* and iq* as the current command Idq* or add the source current commands id* and iq* and the current compensation values idr and iqr, and output the result as the current command Idq*.

In the present embodiment, the synthesizer 113 may include the first synthesis module 113a and the second synthesis module 113b.

The first synthesis module 113a may receive the d-axis source current command id* from the current command generator 111, receive the d-axis current compensation value idr from the current command variable controller 112, and output the d-axis current command Id*.

The second synthesis module 113b may receive the q-axis source current command iq* from the current command generator 111, receive the q-axis current compensation value iqr from the current command variable controller 112, and output the q-axis current command Iq*.

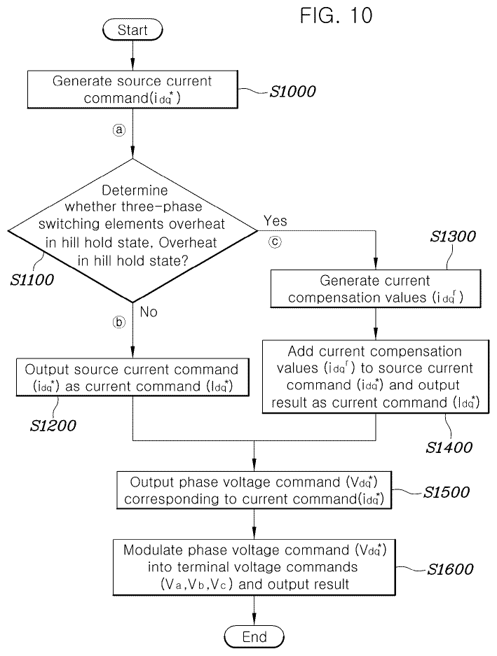

FIG. 10 is a diagram describing a method of controlling an inverter for driving a motor according to another embodiment of the present disclosure.

The step-by-step operations shown in FIG. 10 may be performed by the motor drive system described with reference to FIG. 1, FIG. 2, FIG. 3, FIG. 4, FIG. 5, FIG. 6, FIG. 7, FIG. 8 and FIG. 9.

A method of controlling an inverter for driving a motor will be described hereinafter with reference to FIG. 1, FIG. 2, FIG. 3, FIG. 4, FIG. 5, FIG. 6, FIG. 7, FIG. 8, FIG. 9, and FIG. 10, focusing on the operation of a controller 100.

A current command generation unit 110 may generate a source current command idq* based on an input torque command Te*, an inverse magnetic flux λ−1, and a direct current link voltage Vdc (S1000).

The current command generation unit 110 may determine whether there is overheating in three-phase switching elements (UT, UB, VT, VB, WT, WB) of an inverter 30 in a hill hold state (S1100).

In response that there is no overheating in the hill hold state (S1100—No), the current command generation unit 110 may output the source current command idq* as the current command Idq* (S1200).

In response that there is overheating in the hill hold state (S1100—Yes), the current command generation unit 110 may generate current compensation values idqr corresponding to the torque command Te* and rotor rotation angle θ (S1300).

The current command generation unit 110 may add the current compensation value idqr to the source current command idq* and output the result as the current command Idq* (S1400).

A current controller 120 may then generate and output a phase voltage command (or current control value) Vdq* corresponding to the current command Idq (S1500).

Subsequently, a voltage modulator 130 may perform the PWM to modulate the phase voltage command Vdq* into terminal voltage commands (Va, Vb, Vc) as PWM signals and output these terminal voltage commands to the inverter 30 (S1600).

Therefore, when there is an overheated switching element in the hill hold state, the inverter 30 may operate based on the compensated current command to mitigate overheating in the hill hold state.

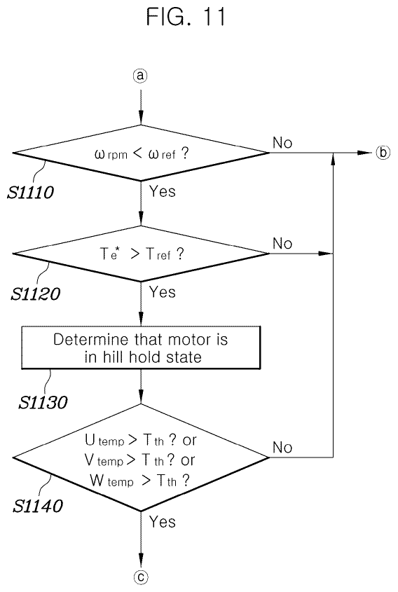

FIG. 11 is a diagram illustrating step S1100 from FIG. 10 in detail.

Referring to FIG. 10 and FIG. 11, the current command generation unit 110 may determine whether a motor rotation speed ωrpm is less than a predetermined reference rotation speed ωref (S1110).

In response that the motor rotation speed ωrpm is greater than or equal to the reference rotation speed ωref (S1110—No) (corresponding to S1100—No in FIG. 10), the current command generation unit 110 may proceed to step S1200.

In response that the motor rotation speed ωrpm is less than the reference rotation speed ωref (S1110—Yes), the current command generation unit 110 may determine whether a torque command Te* exceeds a predetermined reference torque command Tref (S1120).

In response that the torque command Te* is less than or equal to the reference torque command Tref (S1120—No) (corresponding to S1100—No in FIG. 10), the current command generation unit 110 may proceed to step S1200.

In response that the torque command Te* exceeds the reference torque command Tref (S1120—Yes), the current command generation unit 110 may determine that a motor 40 is in a hill hold state (S1130).

The current command generation unit 110 may then determine whether at least one of the junction temperatures (Utemp, Vtemp, Wtemp) of three-phase switching elements (UT, UB, VT, VB, WT, WB) exceeds a predetermined threshold temperature Tth (S1140).

When it is determined that none of the junction temperatures (Utemp, Vtemp, Wtemp) of the three-phase switching elements (UT, UB, VT, VB, WT, WB) exceed the threshold temperature Tth (S1140—No) (corresponding to S1100—No in FIG. 10), in other words, in response that all of the junction temperatures (Utemp, Vtemp, Wtemp) of the three-phase switching elements (UT, UB, VT, VB, WT, WB) are less than or equal to the threshold temperature Tth, the current command generation unit 110 may proceed to step S1200.

In response that it is determined that at least one of the junction temperatures (Utemp, Vtemp, Wtemp) of the three-phase switching elements (UT, UB, VT, VB, WT, WB) exceeds the threshold temperature Tth (S1140—Yes) (corresponding to S1100—Yes in FIG. 10), the current command generation unit 110 may determine that the inverter 30 overheats in the hill hold state and proceed to step S1300.

At step S1300, the current command generation unit 110 may generate current compensation values idqr based on a current compensation map related to the junction temperature determined to exceed the threshold temperature Tth.

Specifically, in response that the junction temperature (Utemp) of the U-phase switching element exceeds the threshold temperature Tth, the current command generation unit 110 may generate the current compensation value idqr based on the U-phase current compensation map.

In response that the junction temperature (Vtemp) of the V-phase switching element exceeds the threshold temperature Tth, the current command generation unit 110 may generate the current compensation value idqr based on the V-phase current compensation map.

In response that the junction temperature (Wtemp) of the W-phase switching element exceeds the threshold temperature Tth, the current command generation unit 110 may generate the current compensation value idqr based on the W-phase current compensation map.

In the embodiments of the present disclosure, the technology of controlling an inverter for driving a motor may be provided to mitigate overheating in the switching element of the inverter in the hill hold state.

Furthermore, the technology of controlling an inverter for driving a motor may be provided to compensate for the current command related to the overheated switching element in the overheating hill hold state, reduce the current input to the overheated switching element, and mitigate overheating in the switching element.

When the technology of controlling an inverter for driving a motor in the embodiments of the present disclosure is applied to a vehicle, it is possible to perform overheat protection control for the switching element in the hill hold state without increasing design costs.

Conventionally, output torque reduction control is performed to prevent damage to the switching element when its temperature increases, resulting in limitations due to reduced hill-climbing performance. However, when the technology of controlling an inverter for driving a motor in the embodiments of the present disclosure is applied, it is possible to perform overheat protection control for the switching element while maintaining hill-climbing performance, as output torque reduction control is unnecessary.

Although the embodiments of the present disclosure have been described in detail with reference to the accompanying drawings, the present disclosure is not limited thereto and may be embodied in many different forms without departing from the technical concept of the present disclosure. Therefore, the embodiments disclosed in the present specification are not intended to limit the technical concept of the present disclosure but are provided for illustrative purposes. The scope of the technical concept of the present disclosure is not confined to these embodiments. Therefore, it should be understood that the above-described embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. An apparatus for controlling an inverter for driving a motor, the apparatus comprising:
a current command generation unit,
wherein the current command generation unit is configured to generate a current command based on a torque command and in response to determining that the motor is in a hill hold state and a junction temperature of any of a plurality of three-phase switching elements in the inverter exceeds a predetermined threshold temperature, generate a current compensation value, vary the current command based on the current compensation value, and output the varied current command.

2. The apparatus of claim 1,
wherein the current command generation unit comprises:
a current command generator configured to generate the current command;
a current command variable controller configured to determine whether the motor is in the hill hold state, determine whether the junction temperature exceeds the threshold temperature in response that the motor is in the hill hold state, and output the current compensation value in response that the junction temperature exceeds the threshold temperature; and
a synthesizer configured to add the current command and the current compensation value and output the added result.

3. The apparatus of claim 2, wherein the current command variable controller is configured to receive the torque command and motor rotation speed, and determine that the motor is in the hill hold state in response that the motor rotation speed is less than a reference rotation speed, and the torque command exceeds a reference torque command.

4. The apparatus of claim 3, wherein the current command variable controller is configured to determine whether the torque command exceeds the reference torque command in response that the motor rotation speed is less than the reference rotation speed.

5. The apparatus of claim 2,
wherein the plurality of three-phase switching elements comprise:
a U-phase switching element, a V-phase switching element, and a W-phase switching element, and
the current command variable controller is configured to determine whether the junction temperature of any of the U-phase, V-phase, and W-phase switching elements exceeds the threshold temperature.

6. The apparatus of claim 5, wherein the current command variable controller is configured to output a U-phase current compensation value in response that the junction temperature of the U-phase switching element exceeds the threshold temperature, output a V-phase current compensation value in response that the junction temperature of the V-phase switching element exceeds the threshold temperature, and output a W-phase current compensation value in response that the junction temperature of the W-phase switching element exceeds the threshold temperature.

7. The apparatus of claim 2, wherein the current command variable controller is further configured to receive a rotation angle of a rotor of the motor and output the current compensation value based on the torque command and the rotation angle.

8. The apparatus of claim 6,
wherein the current command variable controller comprises:
memory configured to store a current compensation map composed of current compensation values for each torque command and rotation angle;
a hill hold overheat determination module configured to determine whether the motor is in the hill hold state, determine whether the junction temperature exceeds the threshold temperature in response that the motor is in the hill hold state, and output an operation-on signal in response that the junction temperature exceeds the threshold temperature; and
a current compensation value output module, in response to the operation-on signal, configured to output the current compensation value matched with the torque command and the rotation angle based on the current compensation map.

9. The apparatus of claim 8, wherein the current compensation map is configured to comprise current compensation values designed to minimize difference between each phase's junction temperature and the average of the sum of the junction temperatures of the U-phase switching element, the V-phase switching element, and the W-phase switching element.

10. A method of controlling an inverter for driving a motor, the method comprising:
generating a current command based on a torque command;
determining whether the motor is in a hill hold state;
determining whether a junction temperature of any of three-phase switching elements in the inverter exceeds a predetermined threshold temperature in response that the motor is in the hill hold state;
outputting a current compensation value in response that the junction temperature exceeds the threshold temperature; and
varying the current command based on the current compensation value and outputting the varied current command.

11. The method of claim 10, wherein the varying the current command comprises adding the current compensation value to the current command.

12. The method of claim 10, wherein the determining of whether the motor is in a hill hold state comprises:
receiving a motor rotation speed; and
determining that the motor is in the hill hold state in response that the motor rotation speed is less than a reference rotation speed, and the torque command exceeds a reference torque command.

13. The method of claim 12, wherein the determining of whether the motor is in a hill hold comprises:
determining whether the motor rotation speed is less than the reference rotation speed; and
determining whether the torque command exceeds the reference torque command in response that the motor rotation speed is less than the reference rotation speed.

14. The method of claim 10, wherein the three-phase switching elements comprise a U-phase switching element, a V-phase switching element, and a W-phase switching element, and
the determining of whether the junction temperature of three-phase switching elements in the inverter exceeds the threshold temperature comprises determining whether the junction temperature of any of the U-phase, V-phase, and W-phase switching elements exceeds the threshold temperature.

15. The method of claim 14, wherein the outputting of a current compensation value comprises outputting a U-phase current compensation value in response that the junction temperature of the U-phase switching element exceeds the threshold temperature, outputting a V-phase current compensation value in response that the junction temperature of the V-phase switching element exceeds the threshold temperature, and outputting a W-phase current compensation value in response that the junction temperature of the W-phase switching element exceeds the threshold temperature.

16. The method of claim 10, wherein the outputting of a current compensation value comprises:
receiving a rotation angle of a rotor of the motor; and
outputting the current compensation value based on the torque command and the rotation angle.

17. A vehicle with a motor as a drive source, the vehicle comprising:
an inverter configured to drive the motor; and
an apparatus configured to control the inverter,
wherein the apparatus comprises a current command generation unit that generates a current command based on a torque command, determines a current compensation value in response that the motor is in a hill hold state and a junction temperature of any of three-phase switching elements in the inverter exceeds a predetermined threshold temperature, and varies the current command based on the current compensation value and outputs the varied current command.
